(19) United States
(12) Patent Application Publication
(10) Pub. No.: US 2008/0080617 A1
(43) Pub. Date: Apr. 3, 2008

(54) MOTION VECTOR DETECTION APPARATUS AND METHOD

(75) Inventor: Tomoya KODAMA, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/846,199

(22) Filed: Aug. 28, 2007

(30) Foreign Application Priority Data
Sep. 28, 2006 (JP) 2006-265847
Jul. 23, 2007 (JP) 2007-190776

(51) Int. Cl. H04N 7/32

(52) U.S. Cl. 375/240.16; 375/E07.123

(57) ABSTRACT

A plurality of motion vector candidates is extracted, which includes motion vectors of a first set of blocks and a second set of blocks each adjacent to an object block. The first set of blocks has the same size as the object block. The second set of blocks has a smaller size than the object block. A first predicted motion vector of the object block is selected from the plurality of motion vector candidates. A residual cost of each neighboring motion vector is calculated. Each neighboring motion vector points a point within a predetermined range from a point pointed by the first predicted motion vector. A second predicted motion vector having the minimum residual cost is selected from the plurality of neighboring motion vectors. If the first predicted motion vector is equal to the second predicted motion vector, the first predicted motion vector is set as the motion vector of the object block. If the first predicted motion vector is not equal to the second predicted motion vector, a search region pointed by the first predicted motion vector is searched by block matching.

### CROSS-REFERENCE TO RELATED APPLICATIONS

This application is based upon and claims the benefit of priority from prior Japanese Patent Application No. 2006-265847, filed on Sep. 28, 2006, and prior Japanese Patent Application No. 2007-190776, filed on Jul. 23, 2007; the entire contents of which are incorporated herein by reference.

### FIELD OF THE INVENTION

The present invention relates to an apparatus and a method for detecting a motion vector of each block necessary for encoding a motion picture.

### BACKGROUND OF THE INVENTION

In motion picture encoding, motion compensation is utilized to remove redundancy between subsequent frames. Motion vector detection processing necessary for motion compensation requires high computational complexity. Various methods to reduce the computational complexity have been proposed. Furthermore, methods for improving vector detection accuracy for the low complexity algorithm have been proposed.

First, a method disclosed in JP-A No. 2005-323299 (Reference 1) is explained. In the video coding standards such as MPEG-4 AVC/H.264, a plurality of block sizes is selectable in an encoder. In this case, by referring to motion vectors of small blocks divided from an object block (to be detected a motion vector), a search center is determined. For example, as shown in FIG. 1, a motion vector of small size blocks (For example, 4×4 pixels) is previously determined. In case of searching a motion vector of the object block (For example, 8×8 pixels), a median value of four motion vectors MV_{A}, MV_{B}, MV_{C} and MV_{D} of four small size blocks A, B, C, and D in the object block is set as a search center.

Second, a method disclosed in JP-A No. 2001-145109 (Reference 2) is explained. By referring to a residual cost corresponding to adjacent blocks to the object block, a threshold of a residual cost of the object block is determined. The residual cost stands for a difference between a block and its motion-compensated block of a reference frame. As the residual cost, “SAD” (=sum of absolute difference) is often used. Thus, at timing that the residual cost of a motion vector is below the threshold during searching the motion vector, search process is terminated (stopped). For example, as shown in FIG. 2, by using blocks A, B, and C adjacent to the object block, motion vectors MV_{A}, MV_{B}, and MV_{C} of each block, and residual cost SAD_{A}, SAD_{B}, and SAD_{C} (In FIG. 2, CME_{A}, CME_{B} and CME_{C}) of each motion vector, a threshold to terminate searching is set as a minimum “SADT=min(SAD_{A}, SAD_{B}, SAD_{C})”.

Next, the most frequent value (2.75, 0) of motion vectors MV_{A}, MV_{B} and MV_{C} of the adjacent blocks is set as a search center. Motion vector of the object block is detected around the search center by the diamond search method disclosed in S. Zhu and K.K.Ma, “A new diamond search algorithm for fast block matching motion estimation,” IEEE Trans. on Image Processing, vol. 9, no. 2, pp. 287-290, Feb. 2000” (Reference 3). As to the diamond search method, a residual cost of each search point of a search pattern around the search center is calculated, the search center is moved to the search point corresponding to the minimum residual cost, and repeated these processes until the minimum residual cost falls on the search center.

In the reference 2, even if the residual cost does not fall on the search center, searching is terminated at the time that the residual cost falls below the threshold. Accordingly, calculation complexity for searching is reduced. However, in the method described in the reference 1, the motion vector may be erroneously detected. In the method described in the reference 2, calculation load for searching is not always reduced.

As to an index “SAD”, the smaller the number of pixels in an object block is, the more sensitive a motion vector of the object block is affected by disturbance (such as a noise). In general, a value of SAD is proportional to the number of pixels in the block (i.e., the size of the block).Nevertheless, supposing Gaussian random noise, noise values of the pixels in the object block and the reference block are mutually canceled, and a noise value in SAD does not increase with the size of the block. Accordingly, sum of difference of two pixel values for larger number of pixels, i.e., SAD of a larger size block, is not relatively affected by noise. Briefly, reliability of motion vector of small size block is not always high.

Furthermore, as to a motion vector of each small size block in the object block, SAD of the motion vector in the small size block has the minimum in comparison with its neighboring motion vectors. For example, in FIG. 1, a motion vector (MV_{B} or MV_{D}) is set as a motion vector MV_{pred}. Using the predicted motion vector MV_{pred} as a search center, SAD of the search center in the small size blocks B and D has the minimum in comparison with that of other search points of the search pattern. Even if a proper motion vector exists at a different position, when the minimum of SAD of the small size blocks B and D is not cancelled by SAD of other small size blocks A and C, processing by the diamond search method cannot be continued. Briefly, motion vector detection based on the iterative search (disclosed in the reference 3) is not matched with the method described in the reference 1, and the motion vector may be erroneously detected. By further applying the method described in the reference 2, the threshold to terminate searching may become larger than that applying the method described in the reference 2 only since SADs of adjacent blocks may become larger. As a result, it is thought that the accuracy of motion vector multiplicatively falls.

Furthermore, in the method described in reference 2, it is assumption that residual costs of adjacent blocks have high correlative with a residual cost of an object block, i.e., motion of the adjacent blocks is similar to motion of the object block. In a scene having a complicated motion or texture, this assumption is not always true. As a result, it is possible that encoding efficiency falls.

FIG. 3 is a graph describing the distribution of difference between the threshold and SAD of the predicted motion vector applying the method in reference 2, using “Standard charts for television system evaluation (http://www.nes.or.jp/gijutsu/kyoiku/ichiran.html (September 2006)) or (http://www.nes.or.jp/standardimage/imagelist.html (July.2007))”, The Institute of Image Information and Television Engineers. The first six frames in three kinds of pictures (No. 10 “streetcar”, No. 35 “horse race”, No. 37 “driving”) are evaluated. Motion vector estimation is based on the diamond search method in reference 3, and a predicted motion vector obtained from adjacent blocks to the object block.

As to two kinds of pictures “horse race” and “streetcar”, almost a half number of blocks can be terminated (stopped) by the threshold without searching process. However, as to one kind of picture “driving”, the number of blocks to be terminated greatly reduces as around 30% because this picture has a widely distributed in comparison with other two pictures. Briefly, a threshold determined from adjacent blocks has a low correlation with SAD of a motion vector of the object block without termination.

Accordingly, in order to raise termination (stop) ratio for such picture, if the threshold is set as a large value, encoding efficiency drops. In other words, as to the picture “driving”, in order to effectively terminate searching, another evaluation index is necessary in addition to the threshold.

### SUMMARY OF THE INVENTION

The present invention is directed to an apparatus and a method for detecting a motion vector of each block between motion pictures with low computational complexity.

According to an aspect of the present invention, there is provided an apparatus for detecting a motion vector of each block divided from a frame in a motion picture, comprising: a candidate extraction unit configured to extract a plurality of motion vector candidates including motion vectors of a first set of blocks and a second set of blocks each adjacent to an object block, the first set of blocks having the same size as the object block, the second set of blocks having a smaller size than the object block; a vector selection unit configured to select a first predicted motion vector of the object block from the plurality of motion vector candidates; a candidate residual cost calculation unit configured to calculate a residual cost of each of a plurality of neighboring motion vectors, the each neighboring motion vector pointing to a point within a predetermined range from a point pointed by the first predicted motion vector; a minimum residual cost selection unit configured to select a second predicted motion vector having the minimum residual cost from the plurality of neighboring motion vectors; a first vector comparison unit configured to compare the first predicted motion vector to the second predicted motion vector; a detection unit configured to detect the first predicted motion vector as the motion vector of the object block if the first predicted motion vector is equal to the second predicted motion vector; and a first search unit configured to search a search region for a motion vector by block matching if the first predicted motion vector is not equal to the second predicted motion vector, the first predicted motion vector pointing to a center of the search region.

According to another aspect of the present invention, there is also provided a method for detecting a motion vector of each block divided from a frame in a motion picture, comprising: extracting a plurality of motion vector candidates including motion vectors of a first set of blocks and a second set of blocks each adjacent to an object block, the first set of blocks having the same size as the object block, the second set of blocks having a smaller size than the object block; selecting a first predicted motion vector of the object block from the plurality of motion vector candidates; calculating a residual cost of each of a plurality of neighboring motion vectors, the each neighboring motion vector pointing to a point within a predetermined range from a point pointed by the first predicted motion vector; selecting a second predicted motion vector having the minimum residual cost from the plurality of neighboring motion vectors; comparing the first predicted motion vector to the second predicted motion vector; detecting the first predicted motion vector as the motion vector of the object block if the first predicted motion vector is equal to the second predicted motion vector; and searching a search region for a motion vector by block matching if the first predicted motion vector is not equal to the second predicted motion vector, the first predicted motion vector pointing to a center of the search region.

According to still another aspect of the present invention, there is also provided a computer readable medium storing program codes for causing a computer to detect a motion vector of each block divided from a frame in a motion picture, the program codes comprising: a first program code to extract a plurality of motion vector candidates including motion vectors of a first set of blocks and a second set of blocks each adjacent to an object block, the first set of blocks having the same size as the object block, the second set of blocks having a smaller size than the object block; a second program code to select a first predicted motion vector of the object block from the plurality of motion vector candidates; a third program code to calculate a residual cost of each of a plurality of neighboring motion vectors, the each neighboring motion vector pointing to a point within a predetermined limit from a point pointed by the first predicted motion vector; a fourth program code to select a second predicted motion vector having the minimum residual cost from the plurality of neighboring motion vectors; a fifth program code to compare the first predicted motion vector to the second predicted motion vector; a sixth program code to detect the first predicted motion vector as the motion vector of the object block if the first predicted motion vector is equal to the second predicted motion vector; and a seventh program code to search a search region for a motion vector by block matching if the first predicted motion vector is not equal to the second predicted motion vector, the first predicted motion vector pointing to a center of the search region.

### BRIEF DESCRIPTION OF THE DRAWINGS

FIG. 1 is an example of motion vector estimation from small blocks in an object block.

FIG. 2 is an example of a cost threshold of the object block based on CME of adjacent blocks.

FIG. 3 is a graph of distribution of difference between the threshold and SAD of the predicted motion vector.

FIG. 4 is a block diagram of a motion vector detection apparatus according to one embodiment.

FIG. 5 is a schematic diagram of a plurality of division patterns in a macro block.

FIG. 6 is a flow chart of motion vector detection describing order of the division patterns.

FIG. 7 is a flow chart of detection processing of motion vector of each block.

FIG. 8 is a schematic diagram of the same size blocks adjacent to the object block.

FIG. 9 is a schematic diagram of small size blocks adjacent to the object block.

FIG. 10 is an example of CME of MV candidates by applying each MV candidate to the object block.

FIG. 11 is a schematic diagram of a search pattern set at S105 in FIG. 7.

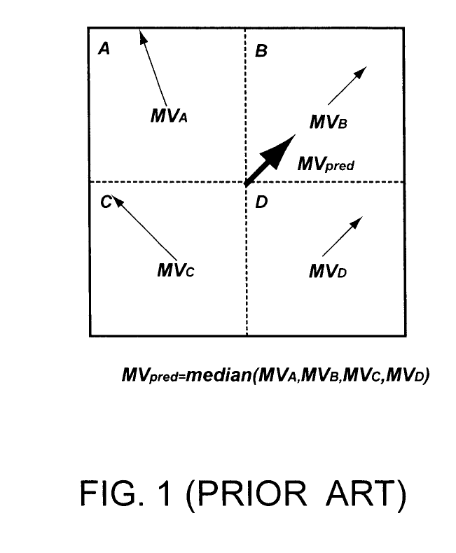

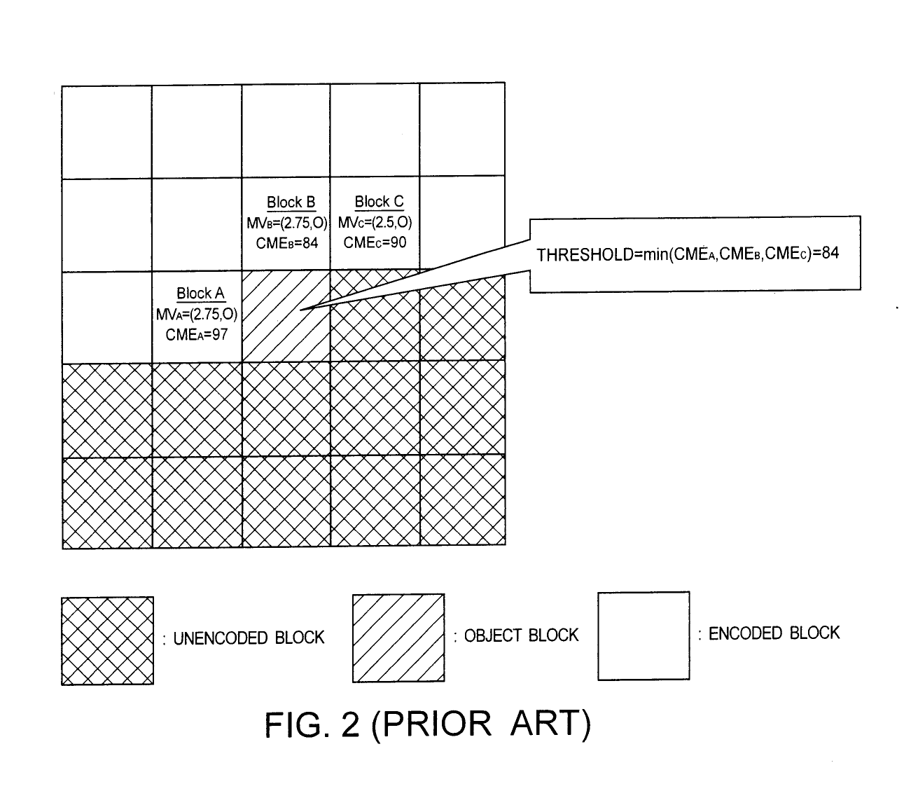

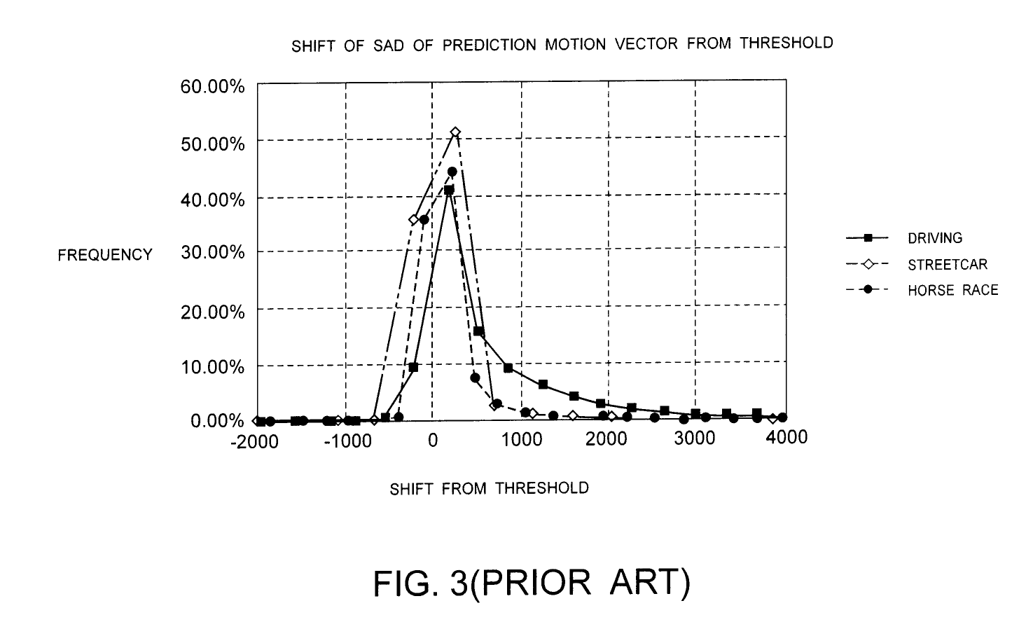

### DETAILED DESCRIPTION OF THE EMBODIMENTS

Hereinafter, various embodiments of the present invention will be explained by referring to the drawings. The present invention is not limited to the following embodiments.

(1) Component of Motion Vector Detection Apparatus:

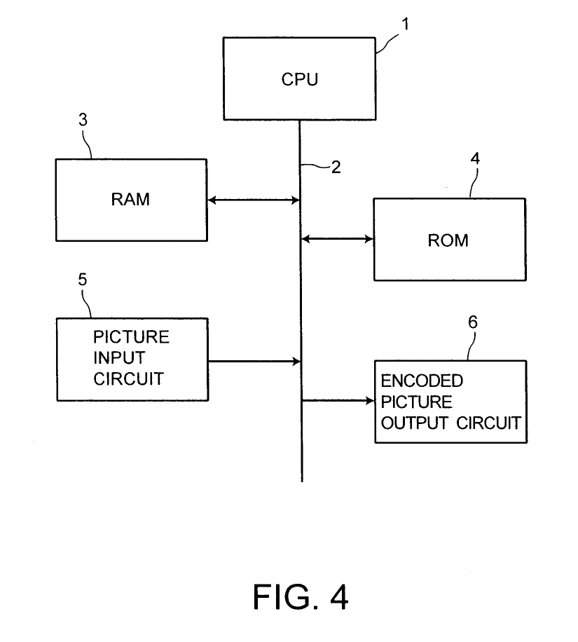

FIG. 4 is a block diagram of the motion vector detection apparatus according to one embodiment. The motion vector detection apparatus is a von Neumann computer having a picture input/output circuit. In FIG. 4, a bus 2 connects to a CPU 1, a RAM 3, a ROM 4, a picture input circuit 5, and an encoded output circuit 6. The ROM 4 stores a program to detect a motion vector. The CPU 1 reads the program from the ROM 4 in order, and executes motion vector detection.

A picture is input via the picture input circuit 5, and temporarily stored in the RAM 3. The CPU 1 detects a motion vector from the picture according to the program. After completing motion vector detection, the CPU 1 reads an encoding program from another region of the ROM 4, and encodes the picture via two-dimensional frequency conversion, quantization and entropy coding. As a result, encoded picture information is output via the encoded picture output circuit 6.

The picture input circuit 5 includes a digital signal input circuit to analog/digital convert a picture signal output from a camera, or a hard-disk drive (or an optical disk) previously storing picture information.

The encoded picture output circuit 6 may be a network interface or a hard-disk drive (or an optical disk) same as the picture input circuit 5. The CPU 1 desirably has an SIMD instruction quickly executable SAD (sum of absolute difference) frequently calculated for motion vector detection. However, in case of the picture having low resolution or low frame rate, a low price CPU for embedded system may be relevant to the CPU 1.

(2) Block to Search a Motion Vector:

In MPEG-4 AVC/H.264, one frame (composing a motion picture) is divided into blocks of 16×16 pixels (which is called a macro block). Encoding is executed for each macro block. Furthermore, the macro blocks can be divided into small blocks such as 4×4, 4×8, 8×8, 8×16, 16×8, and 16×16 pixels for motion compensation. The macro block is composed by combining these division patterns having various block sizes.

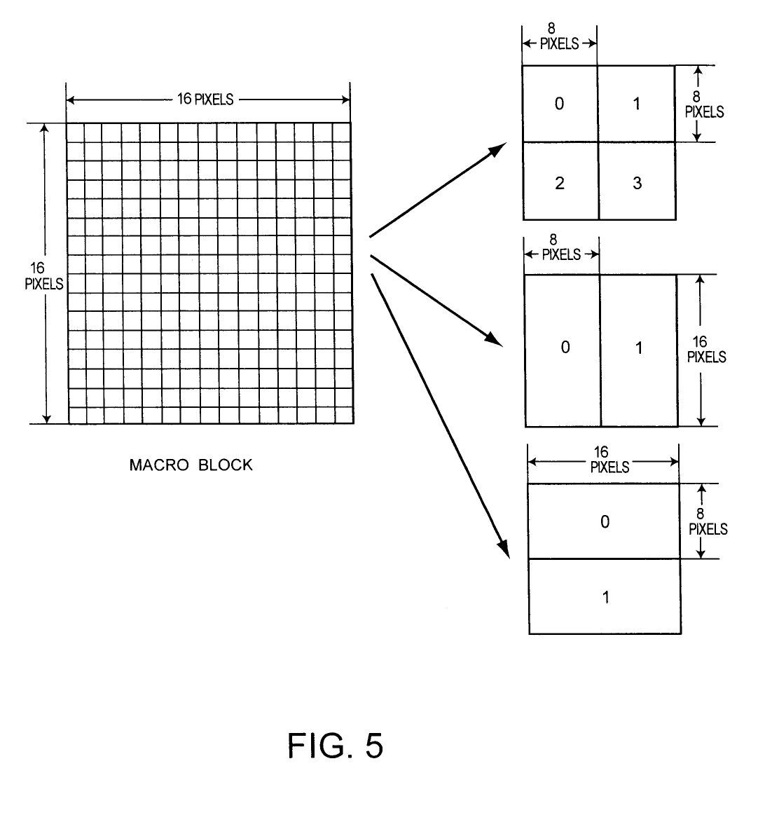

A motion vector is independently assigned to each small block. Briefly, motion vector is detected from each small block included in such division patterns, and the best division pattern is selected. In the present embodiment, in order to simplify, as shown in FIG. 5, motion vector is respectively detected from 8×8 pixels block of four units, 8×16 pixels block of two units, 16×8 pixels block of two units, and 16×16 pixels block of one unit.

(3) Processing of Motion Vector Detection:

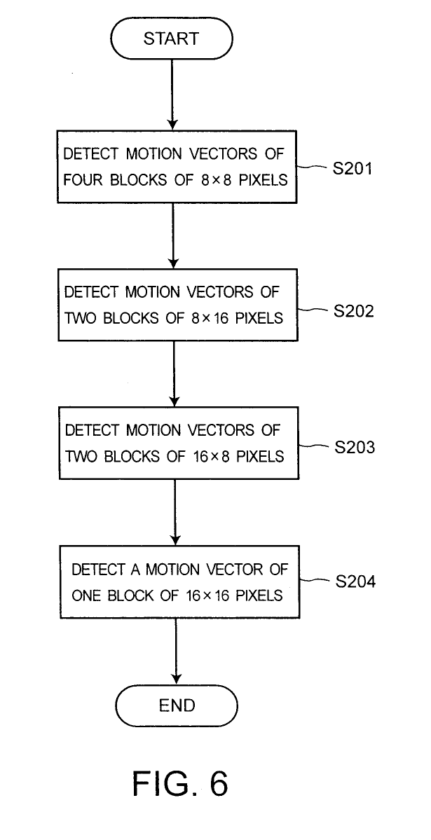

FIG. 6 is a flow chart of processing of motion vector detection. First, motion vectors of 8×8 pixels blocks are detected (S201). Second, motion vectors of 8×16 pixels blocks are detected (S202). Third, motion vectors of 16×8 pixels blocks are detected (S203). Last, a motion vector of a 16×16 pixels block is detected (S204).

In case of detecting a motion vector of each block at S201, S202 and S203, as shown in the right side of FIG. 5, the motion vector is detected in order of number “0→1→2→3”. Briefly, the motion vector of each small block in a macro block is detected by raster scan from the left upper side to the right lower side.

(4) Processing to Detect a Motion Vector of Each Block:

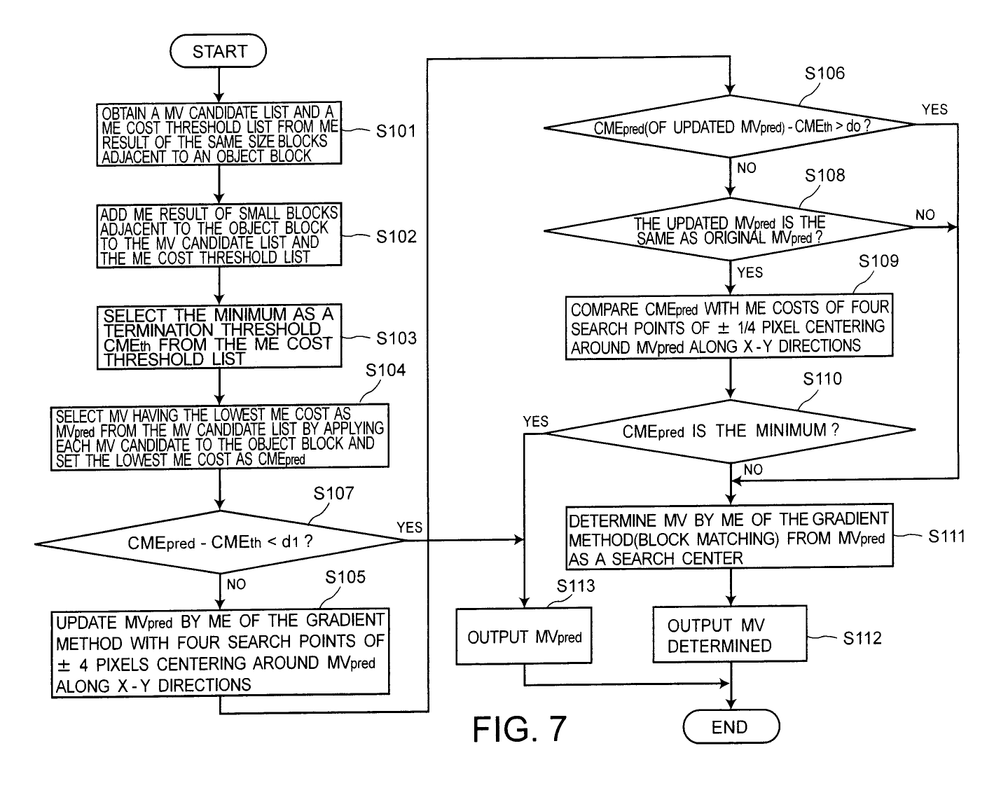

FIG. 7 is a flow chart of processing of motion vector detection of each block. FIG. 7 shows processing of motion vector detection of one block at each step in FIG. 6. In order to explain processing according to the flow chart of FIG. 7, a case that a motion vector is detected from an upper side block “0” of 16×8 pixels in the right lowest side of FIG. 5 is explained.

(4-1) Step 101

First, a motion vector (MV) and a residual cost (CME) of the same size block adjacent to an object block are respectively obtained as a predicted MV candidate and a threshold candidate.

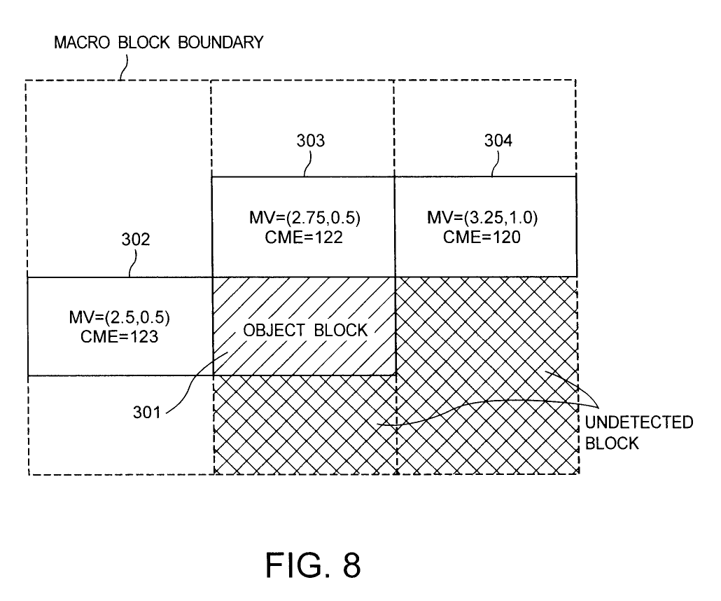

FIG. 8 is an example of the same size blocks adjacent to the object block. In FIG. 8, a residual cost CME is derived from a sum of SAD (sum of absolute difference between a pixel value of the object block and a corresponding pixel value of a reference block) and code length RMV, which results from an entropy coding operation of the corresponding predicted MV candidate, multiplied with a predetermined coefficient λ. The residual cost CME is defined as follows.

$$\begin{matrix}C M E = S A D + λ \times R M V \\ = {\sum }_{x , y ∈ block} \vert R ( x , y ) - C ( x , y ) \vert + λ \times R M V\end{matrix} \qquad ( 1 )$$

In the above equation, R(x,y) represents a pixel value of a coordinate (x,y) on the reference block pointed by MV. C (x,y) represents a pixel value of a coordinate (x,y) on the object block.

In the same size blocks adjacent to the object block 301, three blocks 302, 303, and 304 each having a motion vector (already searched) are extracted. As a result, a set of predicted MV candidates “MV_{pred}_{_{—}}_{cand}” is as follows.

MV_{pred}_{_{—}}_{cand}={(2.5, 0.5), (2.75, 0.5), (3.25, 1.0)}

### Furthermore, a set of threshold candidates “CMEₜₕ_{_{—}}_{cand}” is as follows.

CMEₜₕ_{_{—}}_{cand}={123, 122, 120}

(4-2) Step 102

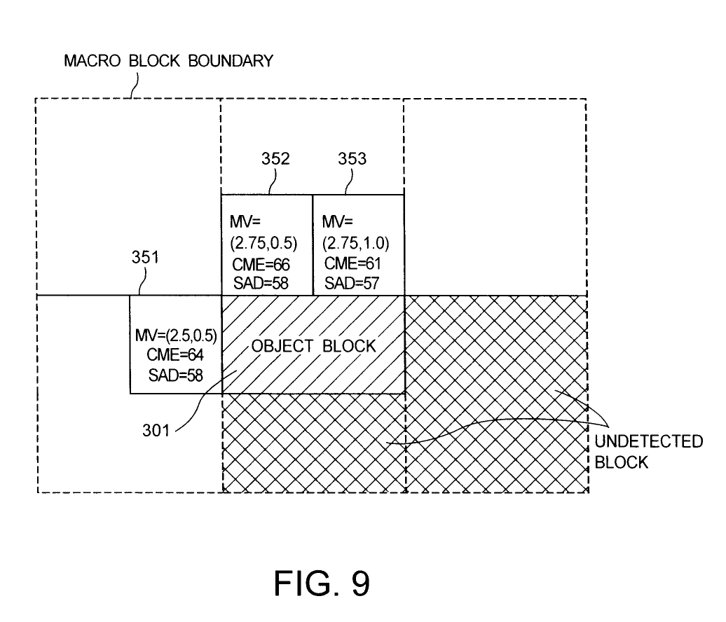

A motion vector (MV) and a residual cost (CME) of small size blocks adjacent to the object block are respectively obtained as a predicted MV candidate and a threshold candidate. FIG. 9 is an example of the small size blocks adjacent to the object block. In FIG. 9, three small blocks 351, 352 and 353 (each having the motion vector) are adjacent to the object block 301. In this case, small blocks satisfying any of following conditions are selected.

one small block located at the most right side in small blocks adjacent to the upper side of the object block

one small block located at the lowest side in small blocks adjacent to the left side of the object block

In FIG. 9, two small blocks 351 and 353 are selected. As a result, a set of predicted MV candidates “MV_{pred}_{_{—}}_{cand}” is as follows. In this case, a plurality of the same values is adjusted as one value.

MV_{pred}_{_{—}}_{cand}={(2.5, 0.5), (2.75, 0.5), (2.75, 1.0), (3.25, 1.0)}

Furthermore, a set of threshold candidates “CMEₜₕ_{_{—}}_{cand}” is obtained from two small blocks 351 and 353. In this case, each area of the two small blocks is a half of an area of the object block. Accordingly, because of a case that a motion vector of the small block is applied to the object block, double value of SAD (the first term in equation (1)) in CME of the small block is added to a list of CMEₜₕ_{_{—}}_{cand}. For example, in case of the small block 353, SAD is 57. Accordingly, a value added to the list is calculated as follows.

SADX×2+λ×RMV=57×2+(61-57)=118

### A plurality of the same values is also adjusted as one value.

CMEₜₕ_{_{—}}_{cand}={123, 122, 120, 118}

(4-3) Step 103

A threshold “CMEₜₕ” is selected from a threshold list CMEₜₕ_{_{—}}_{cand} as follows.

CMEₜₕ=min(CMEₜₕ_{_{—}}_{cand})=118 (2)

(4-4) Step 104

By applying each of the predicted MV candidates to the object block, a predicted MV is selected from the predicted MV candidates based on SAD (not CME: RMV is not included) of each predicted MV candidate.

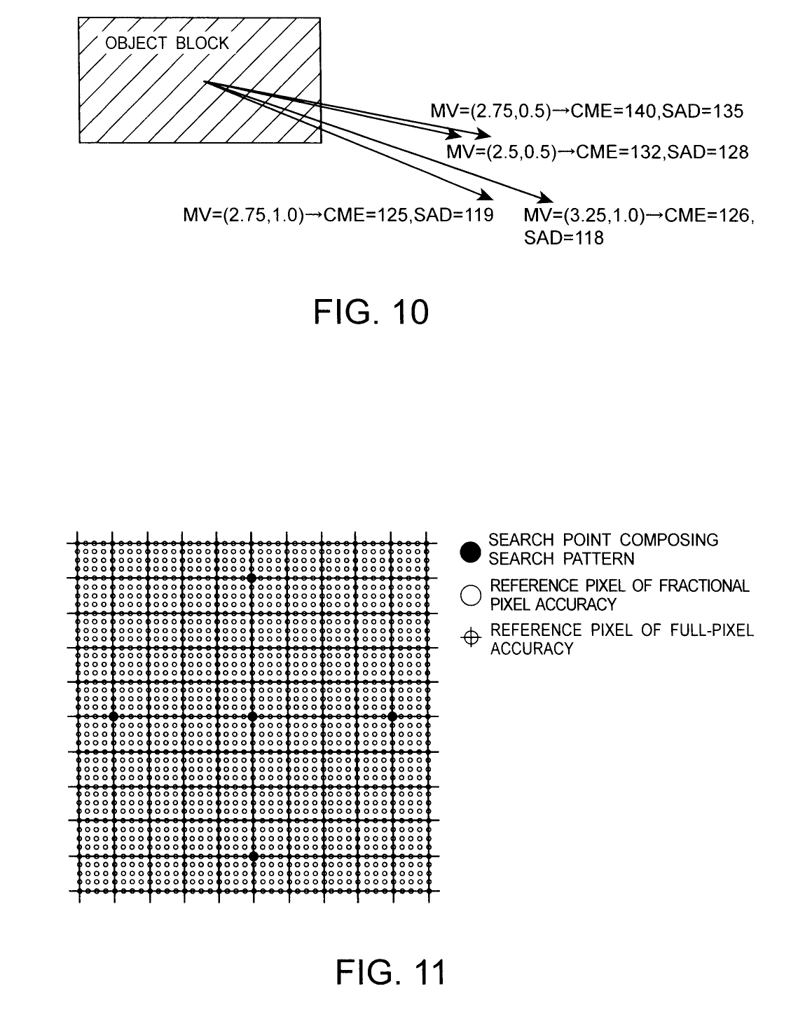

FIG. 10 is an example of SAD of the predicted MV candidates by applying each predicted MV candidate to the object block. In FIG. 10, in case of “MV=(3.25, 1.0)”, SAD “118” is the smallest, and “MV=(3.25, 1.0)” is decided to be nearly a correct motion vector. Accordingly, “MV=(3.25, 1.0)” is selected as a predicted MV of the object block. It is important that the predicted MV candidate is selected using not a residual cost “CME” (defined by equation (1)) but “SAD”. In other words, the residual value is only evaluated without adding similarity with motion vectors of neighboring blocks. As a result, a predicted MV nearer true motion of the object block is selected without being affected by motios of neighboring blocks.

Furthermore, CME “126” of this predicted MV is preserved as a CME_{pred}. Briefly, MV_{pred} is a motion vector predicted from both (large and small) size blocks adjacent to the object block. CME_{pred} is a residual cost calculated by applying MV_{pred} to the object block.

(4-5) Step 107

If CME_{pred} is below or nearly equal to CME_{th,} MV_{pred} is decided to be nearly the most suitable motion vector. In the same way as in reference 2, even if motion vector search is terminated (stopped), a residual value of motion compensation of MV_{pred} is sufficiently small. Accordingly, MV_{pred} is output as a motion vector by terminating the motion vector search.

That is to say, in case of satisfying the following expression, processing is forwarded to S113, and MV_{pred} is output as a motion vector of the object block.

CME_{pred}−CMEₜₕ<d1

where “d1” is a sufficiently small constant.

(4-6) Step 105

Motion vector is coarsely searched around a center pointed by MV_{pred} by accuracy of four (±4) of pixel sample. Concretely, four motion vectors pointing to four positions each depart four pixels along X-direction and Y-direction from a center pointed by MV_{pred} are determined. A residual value of motion compensation of the four motion vectors is calculated.

As mentioned-above, in a picture sequence having a complicated motion, a predicted motion vector obtained from neighboring blocks may be different from a true motion vector of the object block, and the motion vector is often erroneous. Accordingly, a search pattern disclosed in the reference 3 is enlarged as double size, and search points along oblique directions from the search center are omitted as shown in FIG. 11. By searching a motion vector (same as the diamond search method) rough wide range motion estimation is achieved quickly. Furthermore, a motion vector for this search is evaluated using not a residual cost (defined by equation (1)) but “SAD”. As a result, sensitivity for true motion of the object block can rise.

In this way, a predicted motion vector is updated, and preserved as MV_{pred.} An original MV_{pred} (before updating) is preserved as MV_{pred0.} Furthermore, the residual cost corresponding to MV_{pred} is updately preserved as CME_{pred}.

If this CME_{pred} is sufficiently larger than the threshold CMEₜₕ, the most suitable motion vector may exist except for search points already searched (black circles in FIG. 11). At step 105, motion vector search by accuracy of four of pixel sample was only executed. Accordingly, except for search points at intervals of four pixels from a center pointed by the predicted motion vector, a large number of search points exist.

(4-7) Step 106

If the following expression is satisfied, MV_{pred} is not set as a motion vector of the object block, and processing jumps to S111.

CME_{pred}−CMEₜₕ>d0 (3)

where “d0” is a sufficiently large constant (than d1).

(4-8) Step 108

It is decided whether MV_{pred} is equal to MV_{pred0}. If a motion vector of the object block is correctly predicted from motion vectors of neighboring blocks, MV_{pred} has accuracy of sub-pixel (MPEG-4/H.264: one-quarter (±¼) of pixel sample, MPEG-½: one-half of pixel sample). In this case, MV_{pred} should be equal to MV_{pred0}.

If a motion vector of the object block is not correctly predicted from motion vectors of neighboring blocks, MV_{pred} is not equal to MV_{pred0}, and MV_{pred} has accuracy of four of pixel sample only. In this case, a refinement on the MV_{pred} is required by full-pixel and sub-pixel search in order to obtain a motion vector with high accuracy.

In case of “MV_{pred}=MV_{pred0}”, even if CME_{pred} is rather large, MV_{pred} may be the most suitable motion vector for the object block. On the other hand, in case of “MV_{pred}≠MV_{pred0}”, MV_{pred} should not be set as the motion vector, and processing jumps to S111. In this case, CME calculation processing with accuracy of one quarter (±¼) of pixel sample (Step 109) is canceled.

(4-9) Step 109

Minimality of MV_{pred} is checked by comparing four search points existing at ±¼ pixel position depart from a center pointed by MV_{pred} along X-Y directions. Briefly, at each search point of ±¼ pixel position around the center, CME of a motion vector pointing to each search point is calculated. CME of MV_{pred} is compared with CME of each motion vector. If CME of MV_{pred} is the minimum among CMEs of motion vectors of four search points, MV_{pred} is probably the most suitable motion vector of the object block.

(4-10) Step 110

If CME of MV_{pred} is the minimum at S109, processing is forwarded to S113, and MV_{pred} is output as a motion vector of the object block. On the other hand, if CME of MV_{pred} is not the minimum, processing is forwarded to S111.

(4-11) S111, S112

If MV_{pred} is not a motion vector of the object block via above-mentioned steps, processing of S111 is executed. At S111, by the diamond search method disclosed in reference 3, motion vector detection is executed. centering around MV_{pred.} As a result, processing is forwarded to S112. The motion vector searched is output as a motion vector of the object block.

(5) Effect

As mentioned-above, in the present embodiment, a predicted motion vector is searched using motion vectors of both the same size block and a smaller size block each adjacent to an object block. As to the same size block, the motion vector is robust for noise, but has poor sensitivity for motion because the center of the same size block may depart from the object block more than the small size block. As to the small size block, the motion vector may be unstable for noise, but sensitive to motion (having high sensitivity for motion).

The object block does not include small size blocks to be referred. Furthermore, a predicted MV is evaluated by SAD (code length of the predicted motion vector is subtracted from a residual cost of the predicted motion vector). Accordingly, the possibility that a predicted motion vector falls into the local minimum can be reduced, and the predicted motion vector is more correctly detected.

Furthermore, by coarsely searching another motion vector based on SAD starting from the predicted motion vector, incorrect prediction of the motion vector is corrected. Accordingly, above-mentioned possibility that a predicted motion vector falls into the local minimum can be more reduced.

By early terminating (stopping) at two steps (S107 and S110 in FIG. 7) based on thresholding and checking minimality of CME (of the predicted motion vector), early termination may occur more often. In comparison with termination method based on thresholding, termination method based on minimality often raises termination ratio while maintaining accuracy of motion vector estimation. However, in order to decide minimality, for example, CME is calculated for four search points at ±¼ pixel position from a center indicated by the predicted motion vector along X-Y directions. This calculation causes extra computational load. By skipping this decision processing based on thresholding of CME, the computational load can be reduced more than simple addition of effect of individual terminating methods (thresholding and minimality decision).

(6-1) Modification 1

At S104 in FIG. 7, a small block of 8×8 pixels is adjacent to an object block of 16×8 pixels. However, if the object block has 16×16 pixels size, small blocks of 16×8 pixels or 8×16 pixels are adjacent to the object block in addition to the small block of 8×8 pixels. In such case, conditions to obtain a predicted MV candidate and a threshold candidate are as follows.

In small blocks adjacent to the upper side of the object block, one small block existing at the most right side, having the largest size, and having the center nearest the object block, is selected.

In small blocks adjacent to the left side of the object block, one small block existing at the lowest side, having the largest size, and having the center nearest the object block, is selected.

(6-2) Modification 2

At S105 in FIG. 7, the motion vector is coarsely searched with accuracy of four (±4) of pixel sample around a center indicated by MY_{pred}. However, the motion vector may be coarsely searched with accuracy of three (±3) of pixel sample around the center.

(6-3) Modification 3

At step 106 in above embodiment, a threshold is selected as the minimum of residual cost CMEₜₕ_{_{—}}_{cand} of neighboring blocks. However, instead of the minimum at step 103, the maximum is calculated as follows.

CMEₜₕ₂=max(CMEₜₕ_{_{—}}_{cand})=123

In this case, above-mentioned equation (3) may be changes as follows.

CME_{pred}−CMEₜₕ₂>d3(d3: positive constant)

In the disclosed embodiments, the processing can be accomplished by a computer-executable program, and this program can be realized in a computer-readable memory device.

In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software) such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. An apparatus for detecting a motion vector of each block divided from a frame in a motion picture, comprising:
a candidate extraction unit configured to extract a plurality of motion vector candidates including motion vectors of a first set of blocks and a second set of blocks each adjacent to an object block, the first set of blocks having the same size as the object block, the second set of blocks having a smaller size than the object block;
a vector selection unit configured to select a first predicted motion vector of the object block from the plurality of motion vector candidates;
a candidate residual cost calculation unit configured to calculate a residual cost of each of a plurality of neighboring motion vectors, the each neighboring motion vector pointing to a point within a predetermined range from a point pointed by the first predicted motion vector;
a minimum residual cost selection unit configured to select a second predicted motion vector having the minimum residual cost from the plurality of neighboring motion vectors;
a first vector comparison unit configured to compare the first predicted motion vector to the second predicted motion vector;
a detection unit configured to detect the first predicted motion vector as the motion vector of the object block if the first predicted motion vector is equal to the second predicted motion vector; and
a first search unit configured to search a search region for a motion vector by block matching if the first predicted motion vector is not equal to the second predicted motion vector, the first predicted motion vector pointing to a center of the search region.

2. The apparatus according to claim 1,
wherein the second set of blocks has blocks of the largest block size, centers nearest the object block, and the lowest position among blocks adjacent to the left side of the object block or the most right position among blocks adjacent to the upper side of the object block, in blocks having a smaller size than the object block in the frame.

3. The apparatus according to claim 1,
wherein the vector selection unit respectively calculates a prediction residual of motion compensation of the object block by applying each motion vector candidate to the object block, calculates a residual cost of each motion vector candidate based on the prediction residual, and selects a motion vector candidate having the minimum residual cost as the first predicted motion vector.

4. The apparatus according to claim 1, further comprising:
a first threshold calculation unit configured to calculate a first threshold based on a minimum of residual costs of the plurality of motion vector candidates of blocks adjacent to the object block, the residual costs being respectively converted by a size ratio of each of the blocks to the object block;
a first cost comparison unit configured to compare the residual cost of the first predicted motion vector to the first threshold; and
a first decision unit configured to set the first predicted motion vector as the motion vector of the object block without calculation of the residual cost of the neighboring motion vectors if the residual cost of the first predicted motion vector is below the first threshold.

5. The apparatus according to claim 4, further comprising:
a second threshold calculation unit configured to calculate a second threshold above the first threshold based on the minimum of the residual costs if the residual cost of the first predicted motion vector is not below the first threshold;
a second cost comparison unit configured to compare the residual cost of the first predicted motion vector to the second threshold; and
a second decision processing unit configured to execute search processing same as the first search unit without calculation of the residual cost of the neighboring motion vectors if the residual cost of the first predicted motion vector is not below the second threshold.

6. The apparatus according to claim 1, further comprising:
a third threshold calculation unit configured to calculate a third threshold based on a maximum of residual costs of the plurality of motion vector candidates of blocks adjacent to the object block, the residual costs being respectively converted by a size ratio of each of the blocks to the object block;
a third cost comparison unit configured to compare the residual cost of the first predicted motion vector to the third threshold; and
a second decision processing unit configured to execute search processing same as the first search unit without calculation of the residual cost of the neighboring motion vectors if the residual cost of the first predicted motion vector is not below the third threshold.

7. The apparatus according to claim 1, further comprising:
a second search unit configured to search a coarse motion vector based on the residual cost, the coarse motion vector being more than two-pixel accuracy;
a second decision unit configured to set the coarse motion vector as a new first predicted motion vector;
a second vector comparison unit configured to compare the new first predicted motion vector to the first predicted motion vector; and
a third decision processing unit configured to execute search processing same as the first search unit if the new first predicted motion vector is not equal to the first predicted motion vector.

8. The apparatus according to claim 1,
wherein the residual cost of the neighboring motion vector is calculated by adding a sum of absolute difference between a pixel value of the object block and a corresponding pixel value of a region pointed by the neighboring motion vector to a code length to encode the neighboring motion vector multiplied with a predetermined coefficient.

9. The apparatus according to claim 3,
wherein the residual cost of the motion vector candidate is a sum of absolute difference between a pixel value of the object block and a corresponding pixel value of a region pointed by the motion vector candidate.

10. A method for detecting a motion vector of each block divided from a frame in a motion picture, comprising:
extracting a plurality of motion vector candidates including motion vectors of a first set of blocks and a second set of blocks each adjacent to an object block, the first set of blocks having the same size as the object block, the second set of blocks having a smaller size than the object block;
selecting a first predicted motion vector of the object block from the plurality of motion vector candidates;
calculating a residual cost of each of a plurality of neighboring motion vectors, the each neighboring motion vector pointing to a point within a predetermined range from a point pointed by the first predicted motion vector;
selecting a second predicted motion vector having the minimum residual cost from the plurality of neighboring motion vectors;
comparing the first predicted motion vector to the second predicted motion vector;
detecting the first predicted motion vector as the motion vector of the object block if the first predicted motion vector is equal to the second predicted motion vector; and
searching a search region for a motion vector by block matching if the first predicted motion vector is not equal to the second predicted motion vector, the first predicted motion vector pointing to a center of the search region.

11. The method according to claim 10,
wherein the second set of blocks has blocks of the largest block size, centers nearest the object block, and the lowest position among blocks adjacent to the left side of the object block or the most right position among blocks adjacent to the upper side of the object block, in blocks having a smaller size than the object block in the frame.

12. The method according to claim 10,
wherein the first selecting step comprises:
respectively calculating a prediction residual of motion compensation of the object block by applying each motion vector candidate to the object block;
calculating a residual cost of each motion vector candidate based on the prediction residual; and
selecting a motion vector candidate having the minimum residual cost as the first predicted motion vector.

13. The method according to claim 10, further comprising:
calculating a first threshold based on a minimum of residual costs of the plurality of motion vector candidates of blocks adjacent to the object block, the residual costs being respectively converted by a size ratio of each of the blocks to the object block;
comparing the residual cost of the first predicted motion vector to the first threshold; and
setting the first predicted motion vector as the motion vector of the object block without calculating step of the residual cost of the neighboring motion vectors if the residual cost of the first predicted motion vector is below the first threshold.

14. The method according to claim 13, further comprising:
calculating a second threshold above the first threshold based on the minimum of the residual costs if the residual cost of the first predicted motion vector is not below the first threshold;
comparing the residual cost of the first predicted motion vector to the second threshold; and
executing the searching step without calculating step of the residual cost of the neighboring motion vectors if the residual cost of the first predicted motion vector is not below the second threshold.

15. The method according to claim 10, further comprising:
calculating a third threshold based on a maximum of residual costs of the plurality of motion vector candidates of blocks adjacent to the object block, the residual costs being respectively converted by a size ratio of each of the blocks to the object block;
comparing the residual cost of the first predicted motion vector to the third threshold; and
executing the searching step without calculating step of the residual cost of the neighboring motion vectors if the residual cost of the first predicted motion vector is not below the third threshold.

16. The method according to claim 10, further comprising:
searching a coarse motion vector based on the residual cost, the coarse motion vector being more than two-pixel accuracy;
setting the coarse motion vector as a new first predicted motion vector;
comparing the new first predicted motion vector to the first predicted motion vector; and
executing the searching step if the new first predicted motion vector is not equal to the first predicted motion vector.

17. The method according to claim 10,
wherein the residual cost of the neighboring motion vector is calculated by adding a sum of absolute difference between a pixel value of the object block and a corresponding pixel value of a region pointed by the neighboring motion vector to a code length to encode the neighboring motion vector multiplied with a predetermined coefficient.

18. The method according to claim 12,
wherein the residual cost of the motion vector candidate is a sum of absolute difference between a pixel value of the object block and a corresponding pixel value of a region pointed by the motion vector candidate.

19. A computer readable medium storing program codes for causing a computer to detect a motion vector of each block divided from a frame in a motion picture, the program codes comprising:
a first program code to extract a plurality of motion vector candidates including motion vectors of a first set of blocks and a second set of blocks each adjacent to an object block, the first set of blocks having the same size as the object block, the second set of blocks having a smaller size than the object block;
a second program code to select a first predicted motion vector of the object block from the plurality of motion vector candidates;
a third program code to calculate a residual cost of each of a plurality of neighboring motion vectors, the each neighboring motion vector pointing to a point within a predetermined range from a point pointed by the first predicted motion vector;
a fourth program code to select a second predicted motion vector having the minimum residual cost from the plurality of neighboring motion vectors;
a fifth program code to compare the first predicted motion vector to the second predicted motion vector;
a sixth program code to detect the first predicted motion vector as the motion vector of the object block if the first predicted motion vector is equal to the second predicted motion vector; and
a seventh program code to search a search region for a motion vector by block matching if the first predicted motion vector is not equal to the second predicted motion vector, the first predicted motion vector pointing to a center of the search region.
